(19) United States
(12) Patent Application Publication
(10) Pub. No.: US 2017/0109705 A1
(43) Pub. Date: Apr. 20, 2017

(54) CALENDAR OPEN SPOT SCHEDULING

(71) Applicant: SugarCRM Inc., Cupertino, CA (US)

(72) Inventors: Filipe Guerra, San Jose, CA (US); Vladyslav Kulchytskyy, Nashua, NH (US)

(21) Appl. No.: 14/884,473

(22) Filed: Oct. 15, 2015

(51) Int. Cl. G06Q 10/10

(52) U.S. Cl. CPC G06Q 10/1095

(57) ABSTRACT

A method for calendar open spot management includes presenting in a user interface (UI) of a calendaring and scheduling (C&S) computing system a meeting scheduling screen adapted to receive a list of invitees to a meeting and a date, time and duration of the meeting, receiving in the UI a request to schedule a new meeting with a designated invitee at a scheduled date and time for a scheduled duration and additionally receiving in the UI a designated alternative date and time for the new meeting with the designated invitee during which the designated invitee already is scheduled in a calendar of the designated invitee to attend a different meeting. The calendar is monitored and in response to a change in scheduling of the different meeting resulting in unscheduled time during the designated alternative date and time, the new meeting is rescheduled for the designated alternative data and time.

### BACKGROUND OF THE INVENTION

Field of the Invention

The present invention relates to automated calendaring and scheduling (C&S) and more particularly to meeting management in a C&S computing system.

Description of the Related Art

Calendaring and scheduling (C&S) systems have formed the core component of personal information management software and firmware applications for decades. Initially, a mere calendar display, modern calendaring systems provide scheduling and alarm functions in addition to full integration with contact management, time entry, billing and project management applications. The typical calendaring application minimally provides a mechanism for scheduling an event to occur on a certain date at a certain time. Generally, the event can be associated with a textual description of the event. More advanced implementations also permit the association of the scheduled event with a particular contact, a particular project, or both. Furthermore, most calendar applications provide functionality for setting an alarm prior to the occurrence of the event, as well as archival features.

Elemental to any C&S computing system is the meeting. A meeting is defined in an C&S computing system as a block of reserved time at which an end user is to meet one or more other individuals any or all of whom may also be an end user of the C&S computing system. Indeed, where meetings are scheduled in a C&S computing system amongst end users utilizing the C&S computing system, the respective calendars of each of the end users can be presented to the meeting organizer so as to guide the scheduling of the meeting at a particular time and day depending upon the availability of each of the end users.

Oftentimes, the process of collaborative scheduling is embedded as a feature into the meeting scheduling function of the C&S computing system. More particularly, at the time of scheduling a meeting, the C&S computing system can manage a process of negotiating a convenient time amongst invitees to a meeting. However, as it is to be understood, oftentimes, a desirable time for scheduling a meeting is not possible due the scheduling limitations of one of the prospective invitees. Yet, scheduling limitations are dynamic and a prior scheduled meeting previously inhibiting the scheduling of a new meeting often is canceled prior to the date and time of the prior scheduled meeting though too late for re-initiating the process of negotiating the new meeting.

### BRIEF SUMMARY OF THE INVENTION

Embodiments of the present invention address deficiencies of the art in respect to C&S meeting time negotiation and provide a novel and non-obvious method, system and computer program product for calendar open spot management for meeting scheduling in a C&S computing system. In an embodiment of the invention, a method for calendar open spot management for meeting scheduling in a C&S computing system includes presenting in a user interface of the C&S computing system a meeting scheduling screen adapted to receive a list of invitees to a meeting and a date, time and duration of the meeting. The method also includes receiving in the user interface a request to schedule a new meeting with a designated invitee at a scheduled date and time for a scheduled duration and additionally receiving in the user interface a designated alternative date and time for the new meeting with the designated invitee during which the designated invitee already is scheduled in a calendar of the designated invitee to attend a different meeting. The method yet further includes monitoring the calendar of the designated invitee by the C&S computing system.

Finally, in response to detecting a change in scheduling of the different meeting in the calendar resulting in unscheduled time during the designated alternative date and time, the C&S computing system reschedules the new meeting to the occur during the designated alternative data and time for the scheduled duration. In one aspect of the embodiment, the change in scheduling is a cancelation of the different meeting. In another aspect of the embodiment, the change in scheduling is a change to when the different meeting is scheduled. In even yet another aspect of the embodiment, the calendar is managed by the C&S computing system. Alternatively, the calendar is managed by a different, remote C&S computing system.

In another embodiment of the invention, a C&S data processing system is configured for calendar open spot management for meeting scheduling. The system includes a host computing system including at least one computer each with at least one processor and memory. The system also includes a C&S computing system executing in memory of the host computing system. The system yet further includes a calendar open spot management module coupled to the C&S computing system. The module includes program code for presenting in a user interface of the C&S computing system a meeting scheduling screen adapted to receive a list of invitees to a meeting and a date, time and duration of the meeting, for receiving in the user interface a request to schedule a new meeting with a designated invitee at a scheduled date and time for a scheduled duration, for additionally receiving in the user interface a designated alternative date and time for the new meeting with the designated invitee during which the designated invitee already is scheduled in a calendar of the designated invitee to attend a different meeting, for monitoring the calendar of the designated invitee by the C&S computing system and for responding to a detection of a change in scheduling of the different meeting in the calendar resulting in unscheduled time during the designated alternative date and time by re-scheduling by the C&S computing system the new meeting to the occur during the designated alternative data and time for the scheduled duration.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for calendar open spot management for meeting scheduling in a C&S computing system;

FIG. 2 is a schematic illustration of a C&S data processing system configured for calendar open spot management for meeting scheduling; and,

FIG. 3 is a flow chart illustrating a process for calendar open spot management for meeting scheduling in a C&S computing system.

### DETAILED DESCRIPTION OF THE INVENTION

Embodiments of the invention provide for calendar open spot management for meeting scheduling in a C&S computing system. In accordance with an embodiment of the invention, a meeting invite can be transmitted by a meeting organizer to an invitee through a meeting scheduling interface of a C&S computing system. The meeting invite specifies a particular date and time for a meeting. Of note, the meeting organizer can specify an alternate, desirable date and time for the meeting in the interface to the C&S computing system during which the invitee already has scheduled in the C&S computing system a different meeting. However, the C&S computing system monitors the calendar of the invitee and in response to the different meeting becoming canceled or rescheduled to a different date and time in the C&S computing system, the meeting of the meeting organizer is automatically rescheduled to the desirable date and time.

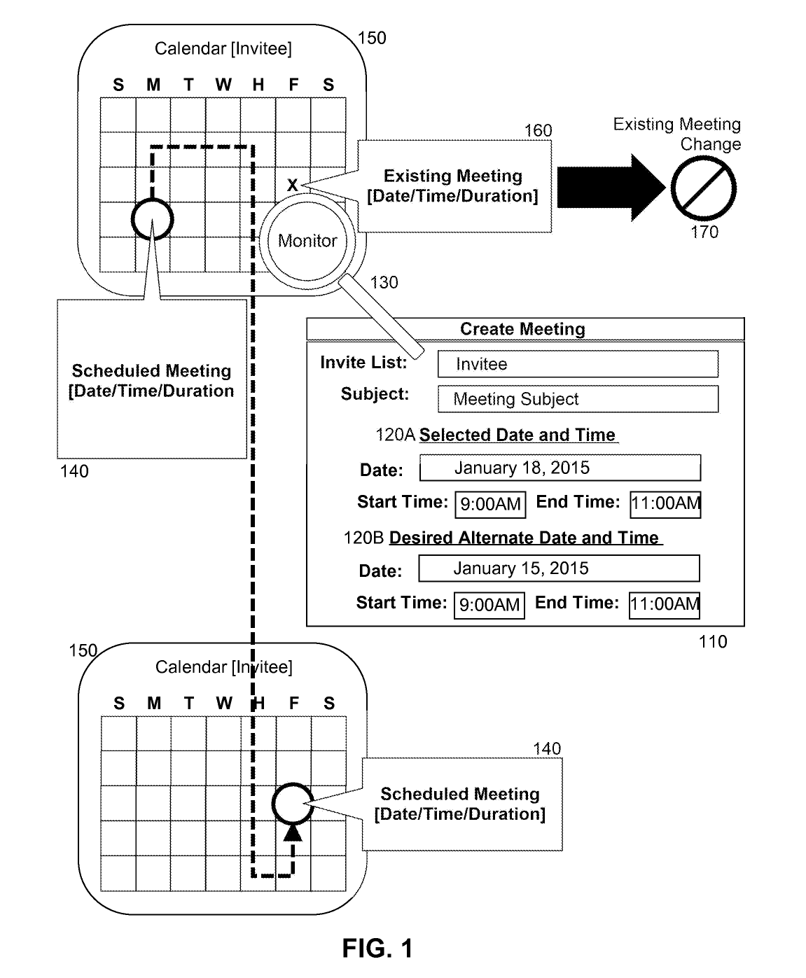

In further illustration, FIG. 1 pictorially illustrates a process for calendar open spot management for meeting scheduling in a C&S computing system. As shown in FIG. 1, an interface 110 to a C&S computing system is displayed in which an end user defines a new meeting to occur with one or more invitees at a selected date and time 120A for a specified duration of time. Within the interface 110, the end user additionally specifies a desired alternate date and time 120B for the meeting that already is scheduled by at least one of the invitees as an existing meeting 160 as denoted in a corresponding calendar 150 of the one of the invitees. Optionally, the alternate date and time 120B can be selected as any available time that is earlier than the selected data and time 120A, or a particular range of times at any date earlier than the selected date and time 120A, such as “mornings” or “afternoons”.

In any event, once the new meeting is defined, the new meeting becomes a scheduled meeting 140 in the calendar 150 of the one of the invitees. A monitor 130 monitors the calendar 150 of the invitee in order to detect a change 170 in the existing meeting 160 so as to result in the date and time previously scheduled for the existing meeting 160 becoming free, unscheduled time. In response to detecting such a change 170, the scheduled meeting 140 is then updated to the desired alternate date and time 120B

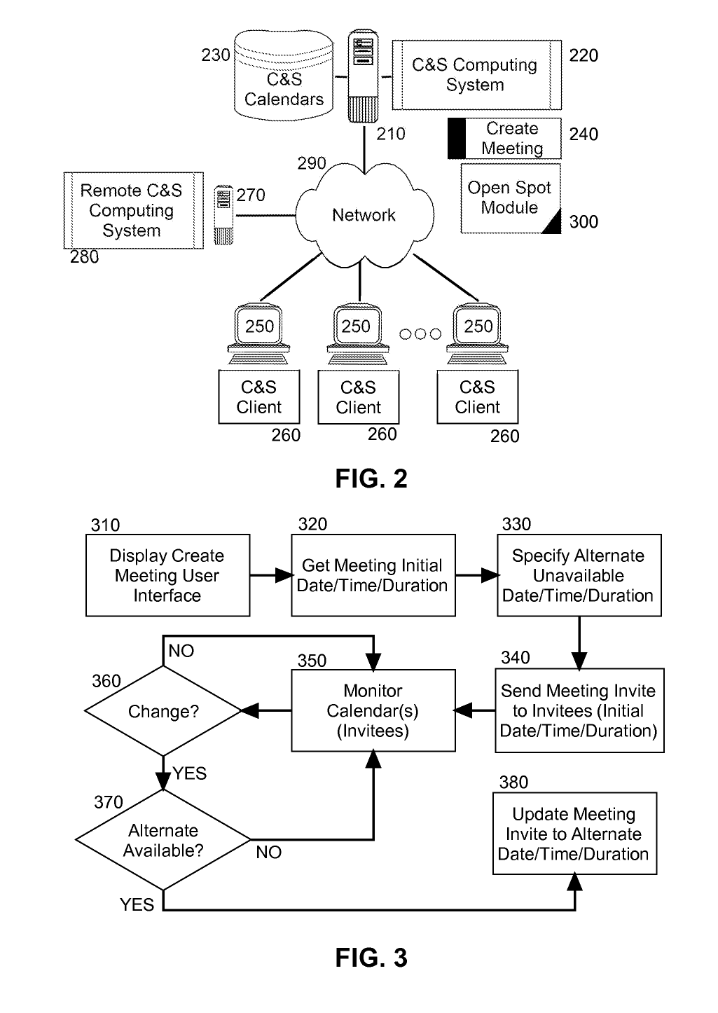

The process described in connection with FIG. 1 is implemented in a C&S data processing system. In yet further illustration, FIG. 2 is a schematic illustration of a C&S data processing system configured for calendar open spot management for meeting scheduling. The system includes a host computing system 210 that includes one or more computers each with memory and at least one processor. The host computing system 210 supports the operation of a C&S computing system 220 managing C&S calendar data 230 including a multiplicity of calendars corresponding to different end users of the C&S computing system 220 accessing the C&S computing system 220 over computer communications network 290 through respectively different C&S client applications executing in corresponding computing devices 250. Of note, the C&S calendar data 230 includes not only calendared meetings defined by the C&S computing system 220 for its end users, but also calendared meetings linked through remote C&S computing system 280 in a different host computing system 270 on behalf of one or more of the end users.

Of note, the C&S computing system 220 includes a create meeting function 240 through which the end users create meetings for placement into the different calendars of different end users accepting resulting invites for the meetings. Coupled to the create meeting function 240 is an open spot module 300. The open spot module 300 includes program code enabled upon execution in the memory of the host computing system 210 to identify an alternate, desired time for a new meeting with an invitee, to monitor an existing meeting scheduled in a calendar of the invitee at the alternate, desired time, to detect a change to the existing meeting so as to render the alternate, desired time as free, unscheduled time and to reschedule the new meeting to the alternate, desired time.

In even yet further illustration of the operation of the open spot module 300, FIG. 3 is a flow chart illustrating a process for calendar open spot management for meeting scheduling in a C&S computing system. Beginning in block 310, a create meeting user interface is displayed and in block 320, an initial date, time and duration is specified for a new meeting along with one or more invitees to the meeting. In block 330, an alternate, desired date and time for the new meeting is specified albeit the alternate, desired data and time is already scheduled for one of the invitees. Thereafter, in block 340 a meeting invite for the new meeting at the specified initial date, time and duration is transmitted to each of the invitees.

In block 350, the calendar of the one of the invitees with the already scheduled block of time at the alternate, desired date and time is monitored for changes in the already scheduled block of time. In decision block 360, if a change is detected, in decision block 370 it is determined whether or not the change has resulted in the alternate, desired date and time becoming available, unscheduled, free time. If so, in block 380 the new meeting is updated to occur at the alternate, desired date and time.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for calendar open spot management for meeting scheduling in a calendaring and scheduling (C&S) computing system, the method comprising:
presenting in a user interface of the C&S computing system a meeting scheduling screen adapted to receive a list of invitees to a meeting and a date, time and duration of the meeting;
receiving in the user interface a request to schedule a new meeting with a designated invitee at a scheduled date and time for a scheduled duration;
additionally receiving in the user interface a designated alternative date and time for the new meeting with the designated invitee during which the designated invitee already is scheduled in a calendar of the designated invitee to attend a different meeting;
monitoring the calendar of the designated invitee by the C&S computing system; and,
responsive to detecting a change in scheduling of the different meeting in the calendar resulting in unscheduled time during the designated alternative date and time, re-scheduling by the C&S computing system the new meeting to the occur during the designated alternative data and time for the scheduled duration.

2. The method of claim 1, wherein the change in scheduling is a cancelation of the different meeting.

3. The method of claim 1, wherein the change in scheduling is a change to when the different meeting is scheduled.

4. The method of claim 1, wherein the calendar is managed by the C&S computing system.

5. The method of claim 1, wherein the calendar is managed by a different, remote C&S computing system.

6. A calendaring and scheduling (C&S) data processing system configured for calendar open spot management for meeting scheduling, the system comprising:
a host computing system comprising at least one computer each with at least one processor and memory;
a C&S computing system executing in memory of the host computing system; and,
a calendar open spot management module coupled to the C&S computing system, the module comprising program code for presenting in a user interface of the C&S computing system a meeting scheduling screen adapted to receive a list of invitees to a meeting and a date, time and duration of the meeting, for receiving in the user interface a request to schedule a new meeting with a designated invitee at a scheduled date and time for a scheduled duration, for additionally receiving in the user interface a designated alternative date and time for the new meeting with the designated invitee during which the designated invitee already is scheduled in a calendar of the designated invitee to attend a different meeting, for monitoring the calendar of the designated invitee by the C&S computing system and for responding to a detection of a change in scheduling of the different meeting in the calendar resulting in unscheduled time during the designated alternative date and time by re-scheduling by the C&S computing system the new meeting to the occur during the designated alternative data and time for the scheduled duration.

7. The system of claim 6, wherein the change in scheduling is a cancelation of the different meeting.

8. The system of claim 6, wherein the change in scheduling is a change to when the different meeting is scheduled.

9. The system of claim 6, wherein the calendar is managed by the C&S computing system.

10. The system of claim 6, wherein the calendar is managed by a different, remote C&S computing system.

11. A computer program product for calendar open spot management for meeting scheduling in a calendaring and scheduling (C&S) computing system, the computer program product comprising a computer readable storage medium having program instructions embodied therewith, the program instructions executable by a device to cause the device to perform a method comprising:
presenting in a user interface of the C&S computing system a meeting scheduling screen adapted to receive a list of invitees to a meeting and a date, time and duration of the meeting;
receiving in the user interface a request to schedule a new meeting with a designated invitee at a scheduled date and time for a scheduled duration;
additionally receiving in the user interface a designated alternative date and time for the new meeting with the designated invitee during which the designated invitee already is scheduled in a calendar of the designated invitee to attend a different meeting;
monitoring the calendar of the designated invitee by the C&S computing system; and,
responsive to detecting a change in scheduling of the different meeting in the calendar resulting in unscheduled time during the designated alternative date and time, re-scheduling by the C&S computing system the new meeting to the occur during the designated alternative data and time for the scheduled duration.

12. The computer program product of claim 11, wherein the change in scheduling is a cancelation of the different meeting.

13. The computer program product of claim 11, wherein the change in scheduling is a change to when the different meeting is scheduled.

14. The computer program product of claim 11, wherein the calendar is managed by the C&S computing system.

15. The computer program product of claim 11, wherein the calendar is managed by a different, remote C&S computing system.
